(19) United States
(12) Patent Application Publication
(10) Pub. No.: US 2008/0230584 A1
(43) Pub. Date: Sep. 25, 2008

(54) Method for Manufacturing a Workpiece by Friction Welding to Reduce the Occurrence of Abnormal Grain Growth

(75) Inventors: Richard J. Lederich, Des Peres, MO (US); John A. Baumann, St. Charles, MO (US)

Correspondence Address: ALSTON & BIRD, LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 11/687,907

(22) Filed: Mar. 19, 2007

(51) Int. Cl. B23K 20/12

(52) U.S. Cl. 228/112.1

(57) ABSTRACT

A method of manufacturing a workpiece is provided. The method generally includes friction stir welding at least one structural member, selectively removing material from the surfaces of the workpiece at the location of a friction stir weld joint, and thereafter subjecting the workpiece to a solution treat, quench, and age treatment. By selectively removing regions from the surfaces of the workpiece that are defined by nonuniform material properties adapted to nucleate nonuniform grain growth during the solution treat, quench, and age treatment, a subsequent grain growth during the thermal treatment can be at least partially prevented.

### BACKGROUND OF THE INVENTION

1) Field of the Invention

Embodiments of this invention relate to the manufacture of a workpiece and, more specifically, to a method of manufacture in which a workpiece is friction welded and the occurrence of abnormal grain growth in the workpiece during a heat treatment operation is reduced or prevented.

2) Description of Related Art

Friction stir welding is a process in which a rotating tool, such as a pin or probe, is urged into and/or through a workpiece, e.g., to join multiple structural members of the workpiece in a solid state or to repair cracks or other defects in a workpiece. According to one conventional friction stir welding process, two structural members are disposed in an abutting or overlapping configuration to define an interface therebetween. A shoulder of the tool that can be flat, concave, or otherwise contoured is urged against one side of the structural members so that a pin of the tool that extends from a shoulder is plunged into the two structural members. The pin is then translated through the structural members along the interface. The motion of the rotating tool generates frictional heating, thereby forming a region of plasticized material in the structural members that is mixed plastically by the tool. Upon cooling of the plasticized material, the members of the workpiece are joined along the weld joint. Friction stir welding is further described in U.S. Pat. No. 6,994,242 to Fuller, et al. and U.S. Pat. No. 5,460,317 to Thomas et al., the entire contents of which are incorporated herein by reference.

Friction stir welding has been demonstrated to be a successful joining method and is used for a variety of materials. However, in some cases the friction welding operation leads to a change in the material properties proximate the weld joint. In particular, the friction stir welding process can result in changes in the material, and these material changes can affect the performance of the material in use or during subsequent processing operations. For example, in a typical operation of friction stir welding high strength aluminum alloys, such as 7000 series alloys, the heat associated with friction stir welding typically results in coarsening of precipitates in a heat affected zone near the friction stir welding joint, thereby decreasing the strength of the material in the heat affected zone. Such high strength aluminum alloys can be subjected to a heat treatment process after welding to restore the strength of the material in the heat affected zone to a condition similar to that of the parent material. Although such a heat treatment process can be effective for improving the properties of the material in the heat affected zone, the heat treatment can also nucleate abnormal grain growth in the nugget portion of the weld joint. That is, the grain size of the material in the weld joint can grow nonuniformly and undesirably during the heat treatment. As a result, when the resulting joint is subjected to loading, the nugget typically deforms nonuniformly, such that the ductility of the joint is reduced (i.e., the joint is more brittle) and the joint is capable of less elongation than the unwelded parent material. Reductions in the ductility of the material can be an indication of reduced fatigue performance. The degree of abnormal grain growth and the amount of strength reduction can be affected by such factors as the heat generated during the friction stir welding operation, the thickness of the joint or other factors that affect the amount of heat generated during friction stir welding, the original material properties, and the characteristics of the heat treatment operation. It is appreciated that other mechanisms impacting this grain growth may be at work. In some cases, the strength reduction can be significant. For example, in a 1-inch thick friction stir weld joint between members of 7000 series aluminum alloys, the strength at the friction stir weld joint can be reduced about 30% relative to the parent material. The use of relatively low-temperature post-weld aging instead of conventional thermal heat treatments has not been found to effectively achieve high strengths at the weld joints.

Thus, a need exists for an improved manufacturing method for friction welding in which the occurrence of abnormal grain growth and strength reduction can be reduced or prevented.

### SUMMARY OF THE INVENTION

Embodiments of the present invention provide methods of manufacturing a workpiece by friction stir welding and an associated workpiece, in which material is selectively removed from the surfaces of the workpiece at the location of a friction stir weld joint to at least partially prevent grain growth during a subsequent thermal treatment.

According to one embodiment, the method includes friction stir welding at least one structural member to form a workpiece defining first and second surfaces and a friction stir weld joint extending between the first and second surfaces, and thereby forming regions near the first and second surfaces defined by nonuniform material properties adapted to nucleate nonuniform grain growth during a solution treat, quench, and age treatment. The workpiece can include first and second plates that are provided in an abutting relationship so that the structural members cooperatively define the first and second surfaces, each of the surfaces having a substantially planar configuration at the friction stir weld joint. Material is selectively removed from the first and second surfaces of the workpiece at the location of the friction stir weld joint, e.g., by machining, to thereby remove the regions from each of the surfaces. Thereafter, the workpiece is subjected to a solution treat, quench, and age treatment, wherein a grain growth during the solution treat, quench, and age treatment is at least partially prevented by the removal of the regions from each surface.

In some cases, a thickness of material of between about 0.050 inch and 0.150 inch, such as a thickness of about 0.100, can be removed from each surface. Material can be removed from each surface in a width that is at least as great as the width of a mechanically affected zone of the friction stir weld joint, and typically at least as great as the width of a heat affected zone of the friction stir weld joint. Material having nonuniformities, such as a relatively greater concentration of oxidized material relative to a remaining material of the weld joint or a grain size greater than a material of the workpiece outside of the friction stir weld joint, can be removed so that the material at the friction stir weld joint after the thermal treatment is characterized by a grain size less than a predetermined maximum grain size, and the predetermined maximum grain size can be about 200 microns, about 10 times the grain size of the material of the workpiece outside of the friction stir weld joint, and/or about 20 times the grain size of the material of the workpiece outside of a nugget of the friction stir weld joint. The at least one structural member can be formed of an aluminum alloy, such as 7050-T7451, and can be solution treated prior to friction stir welding.

According to one embodiment, the method further includes, prior to selectively removing the material, determining a minimum thickness of the material to be selectively removed from each of the first and second surfaces of the workpiece in the removing operation to thereby substantially prevent a nonuniform grain growth during the solution treat, quench, and age treatment. For example, two or more test members can be provided, each test member defining a friction stir weld joint, and different thicknesses of material can be removed from surfaces of the test members at locations of the friction stir weld joints, before subjecting the test members to thermal treatments and then testing the test members to determine the minimum thickness of the material to be selectively removed.

### BRIEF DESCRIPTION OF THE DRAWINGS

The foregoing and other advantages and features of the invention, and the manner in which the same are accomplished, will become more readily apparent upon consideration of the following detailed description of the invention taken in conjunction with the accompanying drawings, which illustrate preferred and exemplary embodiments, but which are not necessarily drawn to scale, wherein:

FIG. 1 is a perspective view illustrating a conventional friction stir welding apparatus configured to form a friction stir weld butt joint in a workpiece that includes two abutting structural members;

FIG. 2 is a section view illustrating a conventional friction stir weld joint formed with the welding apparatus of FIG. 1;

FIG. 3 is a section view illustrating the friction stir weld joint of FIG. 2 after a conventional heat treatment;

FIGS. 4-6 are enlarged section views illustrating portions of the friction stir welding joint of FIG. 3;

FIG. 7 is perspective view schematically illustrating a friction stir weld joint formed according to one embodiment of the present invention after removal of first and second regions and before a thermal heat treatment operation;

FIG. 8 is a section view illustrating a friction stir weld joint formed according to one embodiment of the present invention after a thermal heat treatment operation;

FIG. 9 is a section view illustrating a friction stir weld joint formed according to another embodiment of the present invention;

FIG. 10 is a perspective view illustrating a test member configured for testing according to one embodiment of the present invention;

FIG. 11 is a perspective view partially illustrating five test members formed according one embodiment of the present invention after tensile testing thereof,

FIG. 12 is an enlarged perspective view illustrating one of the partial test members of FIG. 11; and

FIG. 13 is a flow chart illustrating the operations for manufacturing a workpiece according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

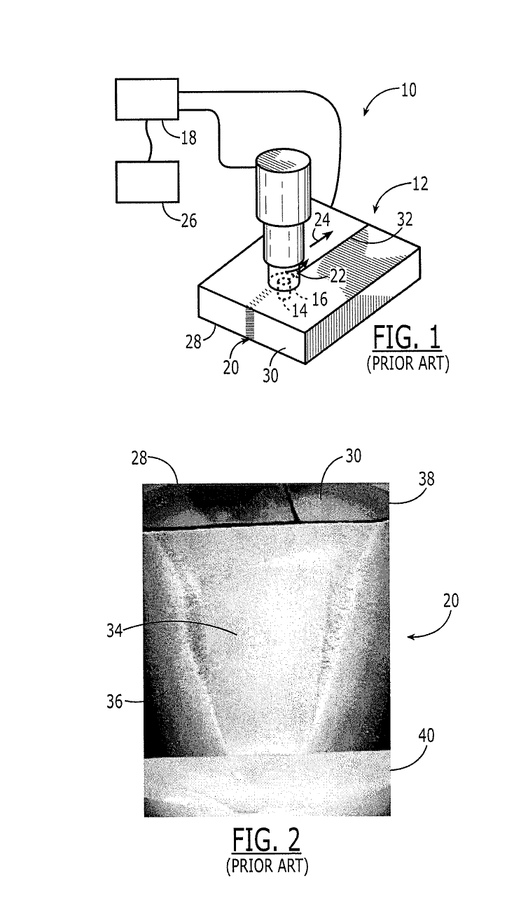

Referring now to the drawings and, in particular, to FIG. 1, there is shown a conventional friction stir welding apparatus 10 for friction stir welding a workpiece 12. The friction stir welding apparatus 10 includes a friction stir welding tool having a pin 14 that extends from a shoulder 16, and at least one actuator 18 for rotating the tool and moving the tool through the workpiece 12 to form a friction weld joint 20. For example, the friction stir welding tool can be engaged to a chuck, spindle, or other member that is engaged to the actuator 16. The actuator 16 can be any of various types of actuating devices, including electric, hydraulic, or pneumatic devices, any of which can include a mechanical linkage. For example, the actuator 16 can be part of a machine, such as a milling machine or a drill, which is structured for rotating the friction stir welding tool in a direction 22 and translating the tool through the workpiece 12 in a direction 24 of the workpiece 12. The actuator 16 be operated manually, but preferably is operated by a computer, microprocessor, microcontroller, or other controller 26, which can be programmed to operate according to a schedule such as a schedule stored in or created by a computer software program.

The term “workpiece” is not meant to be limiting, and it is understood that the workpieces 12 that are friction welded according to the present invention can include one or more structural members, which can be configured in various configurations. For example, as shown in FIG. 1, two structural members 28, 30 are positioned so that the edges of the members 28, 30 are in abutting contact to define an interface 32 therebetween that can be welded to form the joint 20, e.g., a butt weld joint as shown in FIG. 1. Alternatively, the apparatus 10 can be used to form other types of joints such as a lap joint that is formed by overlapping faying surfaces of the structural members and welding through an interface of the faying surfaces to form a lap joint that extends along the interface. The structural members can also be positioned and welded in other configurations, and any number of structural members can be joined by the joint. In another embodiment, the workpiece can include a single structural member, and the friction stir welding apparatus 10 can be used to form a weld joint in the member, e.g., to repair a crack, hole, or other defect therein or to affect the material properties of the structural member. In some cases, the workpiece 12 can be further processed after friction stir welding, such as by machining the workpiece 12 to a desired size or configuration. Methods for friction stir welding a preform that is subsequently trimmed by machining are discussed in U.S. Pat. No. 7,156,276, the entire content of which is incorporated herein by reference.

As illustrated in FIG. 1, the friction stir welding tool includes the shoulder 16 and the pin 14 extending therefrom. The pin 14 and shoulder 16 are preferably formed of a material having high strength and heat resistance. The shoulder 16 is structured to be urged against the workpiece 12 such that the pin 14 is inserted into the workpiece 12, e.g., into the interface as shown in FIG. 1. Alternatively, the tool can include first and second shoulders that are structured in an opposed configuration with a pin extending between the shoulders such that the shoulders can be disposed opposite the workpiece 12 and frictionally engaged to the opposite surfaces of the workpiece 12 therebetween. In either case, each shoulder of the tool can define a surface that is generally flat, tapered, concave, convex, or otherwise shaped, e.g., to engage the workpiece 12 and prevent “plowing,” in which plasticized material from the workpiece 12 is pushed radially outside the circumference of the shoulder as the tool is moved along the workpiece 12. Further, each shoulder can define one or more frictional features, e.g., raised portions or surfaces such as threads, bumps, or ribs that are structured to frictionally engage the workpiece 12. For example, a spiral thread can be provided on each shoulder to engage the workpiece 12. The pin defines a stirring portion that engages the workpiece 12 during welding, and the stirring portion of the pin can be cylindrical or can define a variety of shapes and contours including helical threads, circumferential grooves, ridges, tapers, steps, and the like.

FIG. 2 illustrates a cross-section of the friction stir welding joint 20 formed in the workpiece 12 by the conventional friction stir welding process of FIG. 1. In the illustrated embodiment, each of the structural members 28, 30 of the workpiece 12 is a plate formed of 7050 aluminum alloy having a thickness of 1.3 inch and an initial (i.e., pre-weld) average grain size of between about 20 and 25 microns. The weld joint 20 defines a weld nugget 34 and a heat affected zone 36. The nugget 34 includes a thermal mechanical zone, i.e., a region where the material has been plasticized and mixed by the action of the friction stir welding pin 14. The heat affected zone 36 outside of the nugget 34 is generally defined by material that is not plasticized or mixed during welding, but which is affected by the high temperatures associated with the friction stir welding operation.

The friction stir weld joint 20 is characterized by nonuniform material properties, i.e., nonuniformities, that affect the joint 20 throughout further processing and use. The amount and degree of such nonuniformities typically varies throughout the joint 20. While the nonuniformities are not easily identified, it is believed that the distribution of such nonuniformities is greatest in portions of the joint 20 near the opposite surfaces 38, 40 of the workpiece 12. While the present invention is not limited to any particular theory of operation, it is believed that nonuniformities are formed near, i.e., proximate, the surfaces 38, 40 as a result of the mixing of surface oxides from the surfaces into the joint 20; as a result of excessive strains; and/or as a result of other factors that affect the material of the joint 20 more at the surfaces of the workpiece 12 than the center of the joint 20. It is further believed that the nonuniformities present in the weld joint 20 after friction stir welding can nucleate abnormal grain growth during subsequent treatments. That is, each nonuniformity in the joint 20 is adapted to nucleate, or stimulate, the growth of grains in the local region of the nonuniformity during subsequent processing to sizes that are larger than a normal grain size of the joint 20, such as the average grain size in a central portion of the joint 20 that is substantially unaffected by the nonuniformities. In some cases, the abnormal grain growth during a heat treatment process can result in grain sizes that greatly exceed the grain size of the parent material of the workpiece 12 and the material in the central portion of the joint 20. For example, in some cases, grains can grow to sizes greater than 10 times the grain size of the parent material of the workpiece 12, i.e., the material of the workpiece 12 outside the friction stir weld joint 20, or to sizes greater than 20 times the grain size of the material in the nugget 34 of the weld joint 20.

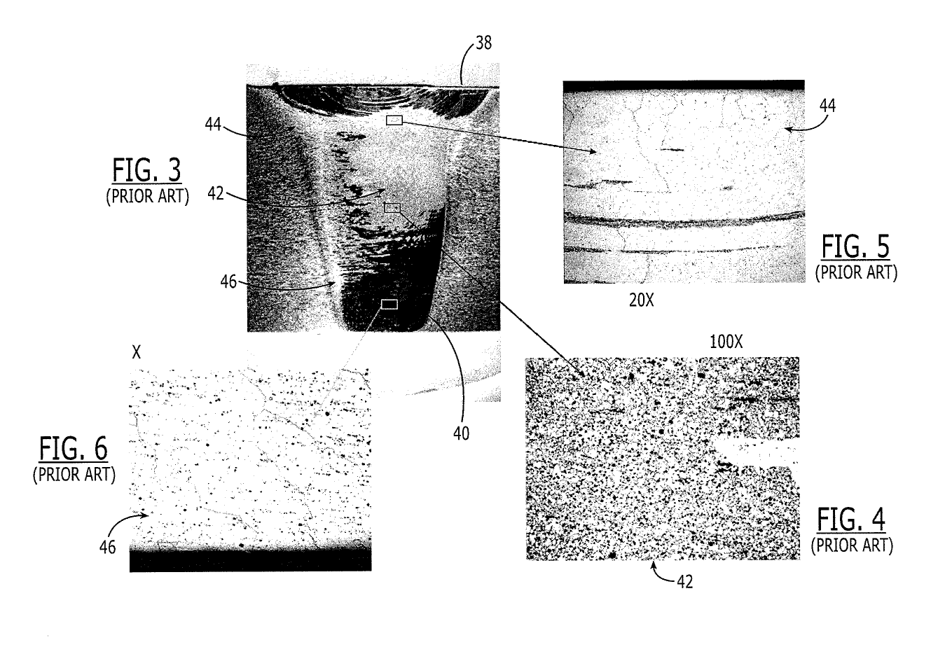

FIG. 3 illustrates a cross-section of the friction stir welding joint 20 of FIG. 2 after a conventional post-weld heat treatment process that includes heating the workpiece 12 to a temperature of 890° F. and maintaining this temperature for an hour, quenching the workpiece 12 in a relatively cool liquid, and aging the workpiece 12, e.g., at a temperature of 250° F. for 6 hours and then a temperature of 325° F. for 24 hours. Such a heat treatment process is typically referred to as a solution treat, quench, and age process, or STQA process.

As illustrated, the weld joint 20 defines various portions having different material properties and, in particular, different grain structures. For example, as illustrated in FIG. 4, a central portion 42 of the joint 20 is characterized by a substantially uniform material with a substantially uniformly refined grain structure. The grain structure in the central portion 42 of the joint 20 is refined relative to the initial material of the workpiece 12, e.g., with average grain sizes of less than 20 microns, such as an average grain size of between about 2 and 15 microns.

Portions of the joint 20 proximate the surfaces 38, 40 of the workpiece 12 are typically characterized by less uniformity and greater grain sizes than the central portion 42 of the joint 20. In particular, as illustrated in FIG. 5, at a first portion 44 adjacent the first surface 38 of the workpiece 12, the grain size of the material is substantially greater than the central portion 42. More particularly, the average grain size in the first portion 44 is about 400 microns. It is believed that the large grains in the first portion 44 are formed during the STQA process as a result of grain growth nucleated or stimulated by the existence of surface oxides from the first surface 38 of the workpiece 12 before friction welding that were mixed into the joint 20 during welding by the pin 14 and/or the shoulder 16. Although such surface oxides can be redistributed throughout the entire height of the weld joint 20, the distribution of the surface oxides is typically greater in the first portion 44 of the joint 20, i.e., nearest the first surface 38 of the workpiece 12.

As illustrated in FIG. 6, a second portion 46 adjacent the second surface 40 of the workpiece 12 is also characterized by less uniformity and greater grain sizes than the central portion of the joint 20. In particular, the material in the second portion 46 has a grain size that is substantially greater than the central portion 42, e.g., about 200 microns. It is believed that the large grains in the second portion 46 are formed during the STQA process as a result of grain growth nucleated or stimulated by the existence of predispositioned material that is formed in or near the second portion 46 during friction welding, i.e., material that is predispositioned as a result of the friction welding process to nucleate grain growth that is abnormally large relative to the other material. Such predispositioning of the material may possibly be a result of high mechanical strains that are imparted to the material during the friction welding process.

It is believed that the removal of material having nonuniformities from the workpiece 12 before the thermal treatment can reduce or eliminate the subsequent abnormal growth of grains in the first and second portions 44, 46 of the workpiece 12. That is, by removing nonuniformities in the material of the weld joint 20, such as oxides that are mixed into the joint 20 or predispositioned or highly sensitized material, the subsequent nucleation of abnormal grain growth during the heat treatment process can be prevented or reduced, thereby at least partially preventing the grain growth that would otherwise occur during the heat treatment process. Thus, according to one method of the present invention, the material removed from one or both of the surfaces 38, 40 of the workpiece 12 can have relatively greater concentrations of oxidized material, highly strained material, or other nonuniformities relative to the remaining material of the weld joint 20.

The nonuniformities can be removed by selectively removing material from the first and second surfaces 38, 40 of the workpiece 12 at the location of the friction stir welding joint 20. Further, the amount of material that is selectively removed can be significantly less than the amount of material that would otherwise be affected by the abnormal grain growth. In other words, the removal of a relatively small region of material can reduce or prevent the abnormal grain growth throughout a larger portion of the joint 20 that includes material not removed from the joint 20.

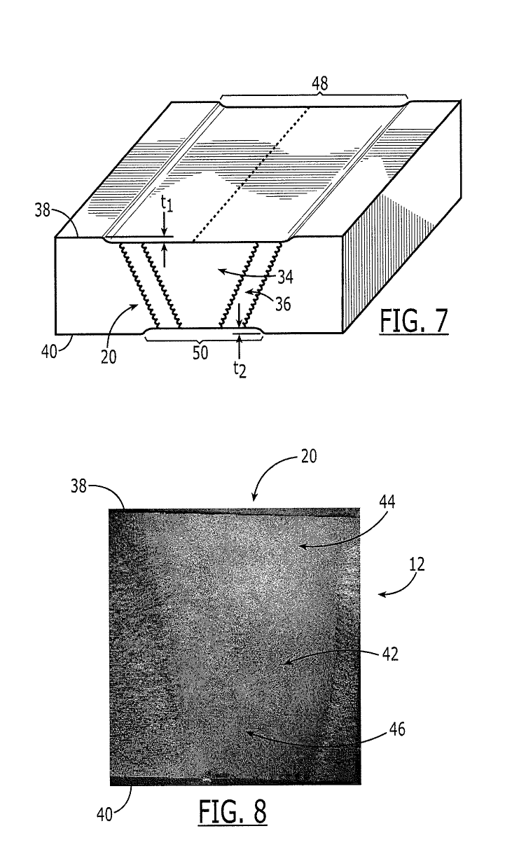

In some cases, the amount of material removed from the joint 20 can be a relatively thin layer from each surface 38, 40. For example, FIG. 7 schematically illustrates the removal of regions from the first and second surfaces 38, 40 of a workpiece 12 according to one embodiment of the present invention. A first region, indicated by reference numeral 48, has been removed from the first surface of the workpiece 12, and a second region, indicated by reference numeral 50, has been removed from the second surface of the workpiece 12. The thickness t₁, t₂ of each removed region 48, 50 is exaggerated in FIG. 7 for purposes of illustrative clarity. In one typical embodiment, the thickness t₁, t₂ of each region 48, 50 removed from each surface 38, 40 is equal to or less than about 0.200 inch, such as between about 0.050 inch and 0.150 inch, and in one specific embodiment, about 0.100 inch.

The first and second regions 48, 50 are typically removed mechanically. For example, a conventional computer numeric control (CNC) machine or similar device can be used to move a rotating machine tool over each surface 38, 40 and thereby mechanically machine or mill the material from the surfaces 38, 40. In some cases, the material can be removed with a machining tool that is actuated by the same machine used for forming the friction stir weld joint. The material can be removed from the entire surfaces 38, 40 so that the contour of each surface 38, 40 is substantially the same after removal of the material. For example, if the surfaces 38, 40 are initially planar, or substantially planar, a uniform thickness of material can be removed across the entire area of each surface 38, 40 so that each surface 38, 40 is also planar after the removal operation. Alternatively, the material can be removed from an area that is smaller than the entire surfaces 38, 40, and typically is removed only from an area proximate the weld joint 20. In particular, the material can be removed from each surface 38, 40 only at locations coincident with the weld joint 20. As shown in FIG. 7, the material is removed from each surface 38, 40 at the location of the friction stir weld joint 20 and, more particularly, from the nugget 34 and the heat affected zone 36 of the joint 20. The sizes and/or configurations of the regions 48, 50 removed from the first and second surfaces 38, 40 can be different, e.g., to correspond to the different sizes of the heat affected zone 36 at each surface 38, 40. The area of removal is typically slightly larger than the heat affected zone 36 as shown in FIG. 7. In some cases, a local portion of the surfaces 38, 40 may be slightly curved and, hence, substantially planar, even though the workpiece 12 defines a nonplanar configuration overall. For example, in the case of a workpiece 12 that defines a relatively large cylindrical shape, such as a cylinder having a diameter of 20 feet or more, the curvature of the inner and outer surfaces is substantially planar (i.e., only slightly curved) even though the workpiece 12 defines a cylindrical shape.

After the removal of the first and second regions 48, 50, the workpiece 12 is subjected to a thermal heat treatment operation, such as a STQA treatment, during which grain growth in the workpiece 12 is at least partially prevented by the removal of the first and second regions 48, 50. For example, the STQA treatment can include heating the workpiece 12 to a solution treat temperature to perform a solution treatment, subsequently quenching the workpiece 12, and subsequently aging the workpiece 12 at an aging temperature less than the solution treat temperature. In one typical embodiment, the workpiece 12 is heated to a solution treat temperature of about 890° F. and maintained at this temperature for about an hour. Thereafter, the workpiece 12 is quenched in a relatively cool liquid, and then aged at a temperature of about 250° F. for about 6 hours and then a temperature of about 325° F. for about 24 hours.

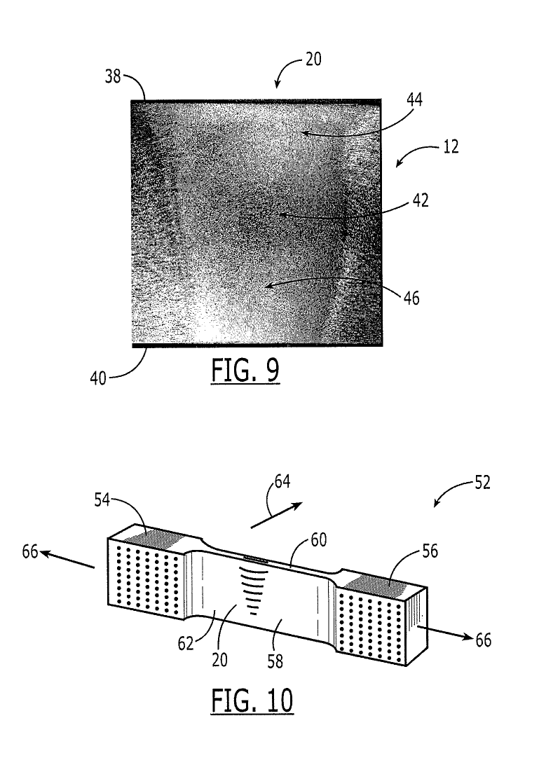

FIG. 8 illustrates a workpiece 12 formed according to one embodiment of the present invention, after a thermal heat treatment operation has been performed. In this embodiment, a thickness t₁, t₂ of about 0.100 inch was removed from each of the surfaces 38, 40 of the workpiece 12 before a STQA treatment as described above. FIG. 9 illustrates a similar workpiece 12 formed according to another embodiment, in which a thickness t₁, t₂ of about 0.150 inch was removed from each of the surfaces 38, 40, and the workpiece 12 was then subjected to the same STQA treatment. As illustrated in FIGS. 8 and 9, the workpieces 12 are not characterized by any (or any substantial) abnormal grain growth. In other words, by removing the nonuniformities at the first and second surfaces 38, 40 of the workpiece 12 prior to the STQA treatment, the undesirable grain growth that would otherwise have occurred during the STQA treatment was prevented. Instead, the friction stir weld joints 20 in the workpieces 12 of FIGS. 8 and 9 have uniform grain structures throughout, including the first and second portions 44, 46 of each joint 20 as well as the central portion 42 of each joint 20. It should be noted that the removal of material prevents abnormal grain growth in other material that is not removed. In other words, by removing a relatively small amount of material prior to the STQA treatment, undesirable grain growth is reduced or prevented throughout the joint 20, including the portions 44, 46 of the joint 20 adjacent the surfaces 38, 40 of the workpiece 12 where abnormal grain grown would otherwise have occurred.

The thickness of material that is to be removed from each surface 38, 40 can be determined before the removal operation and, in some cases, before the workpiece 12 is friction stir welded. For example, prior to friction stir welding a workpiece 12, one or more test coupons or test members can be prepared for determining the minimum thickness that must be removed to substantially prevent the abnormal grain growth during a particular heat treatment operation. A test coupon or test member is typically a small member that has material properties similar to those of the workpiece 12 and which can be tested prior to manufacture of the workpiece 12, e.g., using a standard tensile test device that applies a tensile force to the member until failure. A test member 52 is schematically illustrated in FIG. 10. As illustrated, the test member 52 defines a grip portion 54, 56 at each end and a test portion 58 therebetween. The test portion 58 has a cross-sectional size of about 1.3 inches by about 0.25 inches. The test portion 58 is friction stir welded using a friction stir welding pin having a length of about 1.255 inches, such that, when a shoulder of the friction stir welding tool is urged against a first surface 60 of the test portion 58, the friction stir welding pin extends through the first surface 60 and nearly to an opposite second surface 62 of the test member 58. The rotating friction stir welding pin is translated through the test portion 58 in direction 64, thereby forming a friction stir weld joint 20 in the test member 52. Thereafter, the test member 52 can be milled or machined and then subjected to a STQA treatment. The finished test member 52 can then be tested, e.g., using a conventional tensile test device to grip the grip portions 54, 56 of the test member 52 and apply a tensile force in directions 66 until the test portion 58 breaks.

FIG. 11 partially illustrates five test members 52, individually denoted 2-14-00, 2-14-50, 2-14-100, 2-14-150, and 2-14-200, that were manufactured and tested prior to the manufacture of the workpieces 12 illustrated in FIGS. 8 and 9. Each of the test members 52 defines a friction stir weld joint 20 formed as described above, and the test members 52 were subjected to the STQA treatment described above. Before the STQA treatment, various thicknesses of material were removed from the different test members 52. In particular, a thickness of between 0 inch and 0.200 inch was removed by machining from each surface 60, 62. The test members 52 were then subjected to the tensile test as described above to determine the elongation and strength of each test member 52 before breaking the test member 52 at the weld joint 20. FIG. 11 illustrates one side of each test member 52 after tensile failure thereof so that a break surface 68 of each member 52 is visible. Each test member 52 is identified by a “Spec ID” shown in FIG. 11 and the table below. The final portion of each Spec ID indicates the thickness (in thousandths of an inch) of the material machined from each surface 60, 62 of the test member 52 at the location of the friction stir weld joint 20 prior to the STQA treatment and the tensile test. That is, no material was removed from the first test member 52, denoted 2-14-00; a thickness of 0.050 inch was removed from each surface 60, 62 of the second test member 52, 2-14-50; a thickness of 0.100 inch was removed from each surface 60, 62 of the third test member 52, 2-14-100; a thickness of 0.150 inch was removed from each surface 60, 62 of the fourth test member 52, 2-14-150; and a thickness of 0.200 inch was removed from each surface 60, 62 of the fifth test member 52, 2-14-200.

| Spec ID | Fty (ksi) | Ftu (ksi) | % Elongation |
|---|---|---|---|
| 2-14-00 | 66.2 | 69.9 | 2.6 |
| 2-14-50 | 66.0 | 72.4 | 4.7 |
| 2-14-100 | 65.7 | 72.5 | 5.7 |
| 2-14-150 | 65.8 | 72.2 | 4.7 |
| 2-14-200 | 66.7 | 73.1 | 5.2 |

The above table indicates the tensile yield strength (Fty), the ultimate tensile strength (Ftu), and the percent tensile elongation for each test member 52. The test members 52 of FIG. 11, as well as the workpieces 12 of FIGS. 8 and 9, are formed of aluminum alloy 7050-T7451, a conventional solution treated aluminum alloy. For comparison, this aluminum alloy (outside of the portion that is affected by the friction stir welding) is characterized by the following properties: tensile yield strength (Fty) of 67 ksi, ultimate tensile strength (Ftu) of 76 ksi, and tensile elongation of 10 percent.

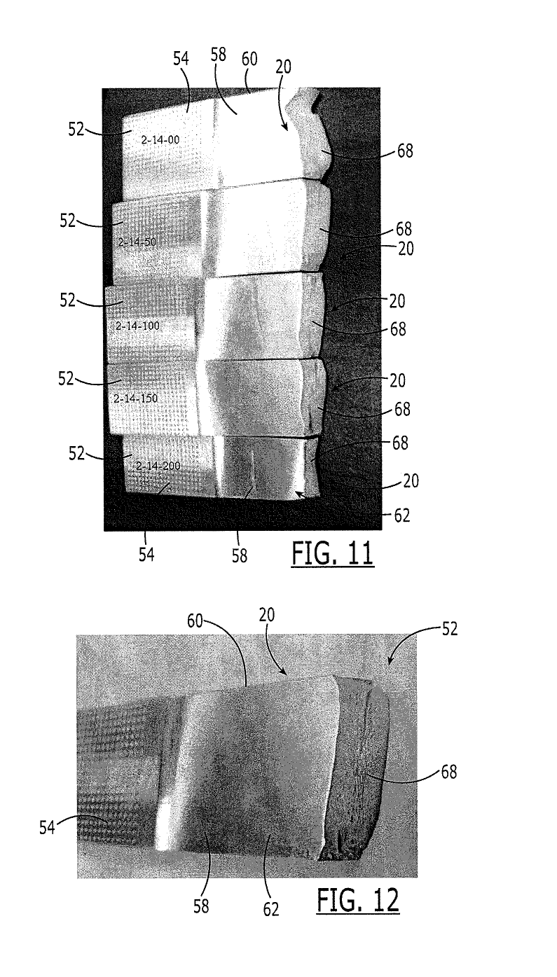

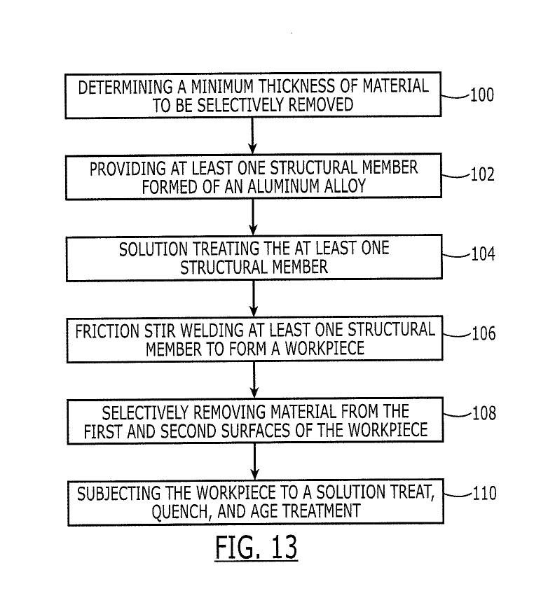

As evident from the above table, the first test member 52, 2-14-00, which was not machined before the STQA treatment, fractured in a brittle manner, with little tensile elongation (2.6%). The other test members 52, denoted 2-14-50, 2-14-100, 2-14-150, and 2-14-200, which were machined prior to the STQA treatment, exhibited more ductile failures with greater elongation (4.7% or greater). Further, the test members 52 that were machined prior to the STQA treatment exhibited greater strengths that are closer to that of the parent material (7050-T7451). As illustrated in FIG. 12, a small amount of grain growth occurred near the second surface 62 of the fourth test member 52, denoted 2-14-150; however, the amount of grain growth was significantly less than in the unmachined workpiece 12 illustrated in FIG. 3. Significant improvements were achieved by the removal of 0.050 inch or more from each surface 60, 62 and, in particular, by the removal of 0.100 inch or more from each surface 60, 62. In fact, the removal of 0.100 inch from each surface 60, 62 achieved improved properties similar to those of the test members 52 denoted 2-14-150 and 2-14-200, from which greater amounts of material were removed.

In other embodiments of the present invention, the workpieces 12 can be manufactured without the use of such test members 52, and the minimum amount of material to be removed from each surface 38, 40 of a workpiece 12 can be determined in other manners. For example, in some cases, the amount of material to be removed can be determined according to testing or examination of the workpiece 12 prior to thermal treatment. Alternatively, the amount of material to be removed from each surface 38, 40 can be determined by theoretical or analytical methods, or by other empirical methods such as according to data determined from other workpieces 12 of similar or dissimilar materials.

The removal of material from the surfaces 38, 40 generally requires additional processing. Further, removal of significant amounts of material from the workpiece 12 can increase the time and expense for manufacture, as well as require the use of larger workpiece 12 thicknesses in order to achieve the desired sizes after machining. Accordingly, the minimum amount of material to be removed from each surface 38, 40 generally refers to the minimum thickness that must be removed from each surface 38, 40 so that no or minimal abnormal grain growth occurs during the subsequent thermal processing. The minimum thickness to be removed can differ for the different surfaces 38, 40. That is, in some cases, it may be necessary to remove a greater amount of material from one of the surfaces 38, 40 than the other surface 38, 40 to reduce or prevent abnormal grain growth during the thermal treatment.

It is appreciated that the thickness t₁, t₂ of material that must be removed from each surface 38, 40 in order to reduce and/or prevent abnormal grain growth during a subsequent thermal treatment can vary depending on such factors as the material of the workpiece 12, the dimensions and configuration of the workpiece 12, the temperature that results in the workpiece 12 during friction stir welding, the type and size of friction stir welding tools that are used, the operating parameters of the friction stir welding machine such as the rotational and translational speed of the friction stir welding tool, and the like.

FIG. 13 illustrates the operations for manufacturing a workpiece 12 according to one embodiment of the present invention. In some cases, the method includes determining a minimum thickness of material that is to be selectively removed. See block 100. Before or after the minimum thickness is determined, at least one structural member is provided. See block 102. In some cases, the at least one structural member is solution treated or provided in a solution treated condition, e.g., as aluminum alloy 7050-T7451. See block 104. The at least one structural member is friction stir welded to form a workpiece 12. See block 106. As a result of the friction stir welding operation, regions are formed near the first and second surfaces defined by nonuniform material properties adapted to nucleate nonuniform grain growth during a subsequent heat treatment. Material is then selectively removed from the first and second surfaces of the workpiece 12 to thereby remove the regions of nonuniform material properties. See block 108. Thereafter, the workpiece 12 is subjected to a solution treat, quench, and age treatment, with a grain growth during the solution treat, quench, and age treatment being at least partially prevented by the removal of the regions on each surface. See block 110.

The methods provided by the present invention can be used for joining thick workpieces, such as plates or other members having thicknesses of 1 inch or more. In some cases, the workpieces can be subjected to significant strains, heat, and oxide introduction during friction stir welding. In this regard, relative to thin workpieces, such thick workpieces generally require larger friction stir welding pins and slower speeds of translation during friction stir welding, such that greater amounts of thermal energy are generated during friction welding, potentially introducing great nonuniformities in the resulting weld joints.

Friction stir welding can be used to process structural members that are formed of a variety of materials including, but not limited to, aluminum, aluminum alloys, titanium, titanium alloys, steel, and the like. Non-metal materials can also be welded with the friction stir welding apparatus, e.g., materials such as polymers and the like. Further, the workpiece can include members of similar or dissimilar materials, for example, structural members formed of different metals, including metals that are unweldable or uneconomical to join by conventional fusion welding techniques. Unweldable materials, when joined by conventional fusion welding techniques, produce relatively weak weld joints that tend to crack during weld solidification. Such materials include aluminum and some aluminum alloys, particularly AA series 2000 and 7000 alloys. The use of friction stir welding permits workpieces formed of unweldable materials to be securely joined. Friction stir welding also can be used to securely join weldable materials to other weldable and to unweldable materials.

The workpieces formed according to the present invention can be used in a variety of applications, including, for example, frames, panels, skins, airfoils, and the like for aeronautical and aerospace structures such as aircraft and spacecraft, for marine vehicles, automobiles, trucks and trailers, railcars, and the like, as well as for other applications outside of the transportation industry. The friction stir welded workpieces can be large and/or can have curvilinear or other complex geometries. In some applications, the structural members of the workpiece are joined in geometrical configurations that make difficult, or prevent, access to the opposing sides of the workpiece. For example, the structural members can be joined to form a partially or fully closed body such as a tube or an airplane wing. While friction stir welded butt joints are illustrated in the application, it is appreciated that the present invention can also be applied to the formation of other joints, such as friction stir welded lap joints in which one member overlaps another member.

Many modifications and other embodiments of the invention will come to mind to one skilled in the art to which this invention pertains having the benefit of the teachings presented in the foregoing descriptions and the associated drawings. For example, the structural members and/or the workpieces can be otherwise processed before and/or after joining by friction welding. Such processing can include cleaning the joining surfaces of the structural members to remove oxidation or surface defects. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of manufacturing a workpiece, the method comprising:
friction stir welding at least one structural member to form a workpiece defining first and second surfaces and a friction stir weld joint extending between the first and second surfaces, and thereby forming a region near each of the first and second surfaces defined by nonuniform material properties adapted to nucleate nonuniform grain growth during a solution treat, quench, and age treatment;
selectively removing material from the first and second surfaces of the workpiece at the location of the friction stir weld joint and thereby removing the regions from each of the surfaces; and
thereafter subjecting the workpiece to a solution treat, quench, and age treatment, wherein grain growth during the solution treat, quench, and age treatment is at least partially prevented by the removal of the regions from each surface.

2. A method according to claim 1 wherein said friction stir welding step comprises friction stir welding first and second plates in an abutting relationship such that the structural members cooperatively define the first and second surfaces, each of the surfaces having a planar configuration at the friction stir weld joint.

3. A method according to claim 1 wherein said selectively removing step comprises mechanically milling material from each of the first and second surfaces.

4. A method according to claim 1 wherein said selectively removing step comprises removing a thickness of material of between about 0.050 inch and 0.150 inch from each surface.

5. A method according to claim 1 wherein said selectively removing step comprises removing a thickness of material of about 0.100 inch from each surface.

6. A method according to claim 1 wherein said selectively removing step comprises removing a width of material from each surface at least as great as the width of a heat affected zone of the friction stir weld joint.

7. A method according to claim 1 wherein said selectively removing step comprises removing material having a grain size greater than a material of the workpiece outside of the friction stir weld joint such that the material at the friction stir weld joint after the subjecting step is characterized by a grain size less than a predetermined maximum grain size.

8. A method according to claim 1 wherein said selectively removing step comprises removing material having a relatively greater concentration of oxidized material relative to a remaining material of the weld joint.

9. A method according to claim 1 wherein the predetermined maximum grain size of the material at the friction stir weld joint is about 200 microns.

10. A method according to claim 1 wherein the predetermined maximum grain size is about 10 times the grain size of the material of the workpiece outside of the friction stir weld joint.

11. A method according to claim 1 wherein the predetermined maximum grain size is about 20 times the grain size of the material of the workpiece outside of a nugget of the friction stir weld joint.

12. A method according to claim 1 wherein said subjecting step comprises heating the workpiece to a solution treat temperature to perform a solution treatment, subsequently quenching the workpiece, and subsequently aging the workpiece at an aging temperature less than the solution treat temperature.

13. A method according to claim 1, further comprising providing the at least one structural member formed of an aluminum alloy.

14. A method according to claim 1, further comprising solution treating the at least one structural member prior to the friction stir welding step.

15. A method according to claim 1, further comprising, prior to said selectively removing step, determining a minimum thickness of the material to be selectively removed from each of the first and second surfaces of the workpiece in said removing step to thereby substantially prevent a nonuniform grain growth during the solution treat, quench, and age treatment.

16. A method according to claim 1 wherein said determining step comprises providing at least two test members, each test member defining a friction stir weld joint, removing different thicknesses of material from surfaces of the test members at locations of the friction stir weld joints, subjecting the test members to thermal treatments, and testing the test members to determine the minimum thickness of the material to be selectively removed.

17. A method according to claim 1 wherein said friction stir welding step comprises friction stir welding first and second plates in an abutting relationship such that the structural members cooperatively define the first and second surfaces, each of the surfaces having a substantially planar configuration at the friction stir weld joint.

18. A workpiece manufactured according to the method of claim 1.
